(19) United States
(12) Patent Application Publication
(10) Pub. No.: US 2014/0230028 A1
(43) Pub. Date: Aug. 14, 2014

(54) Auxiliary password

(71) Applicant: Stephen Oscar Petty, Coronado, CA (US)

(72) Inventor: Stephen Oscar Petty, Coronado, CA (US)

(21) Appl. No.: 14/176,145

(22) Filed: Feb. 9, 2014

Related U.S. Application Data
(60) Provisional application No. 61/762,959, filed on Feb. 10, 2013.

(51) Int. Cl. G06F 21/46

(52) U.S. Cl. CPC G06F 21/46
USPC 726/6

(57) ABSTRACT

A method to provide trusted parties an auxiliary access password that allows access to password protected data while allowing the owner of the data to keep the data secure until certain events occur. Two or more Key Elements are created that can be concatenated in any order or in a specified order to become a valid alternative to the primary password. The Key Elements are shared with trusted parties or institutions that are trusted by the User. The Key Element instructions for each of the trusted parties include a specific time, event or occurrence, such as the death or incapacitation of the owner of the data, when the trusted parties should give their Key Elements to a designated trusted party who will concatenate the Key Elements to gain access to the password protected data.

### BACKGROUND OF THE INVENTION

The present invention is in the technical field of security.

More particularly, the present invention is in the technical field of a device, method and system for authenticating access to a password protected account, program, machine or device (hereinafter referred to as an “Account”) by the owner of the account, program, machine or device (hereinafter referred to as the “User”).

A password is typically required to gain access to an Account one wants to protect. The password is normally stored using a flat file, a database, LDAP or other storage mechanisms (hereinafter referred to as “Storage” or “Stored”). To provide another level of protection, some Accounts also require and Store a PIN, or personal identification number, in addition to a password.

Users are advised to protect their passwords to prevent unauthorized access to the Account. The User should not give the password to anyone who is not intended to have full and total access to the Account.

Security and protection of personal and business information is important. Keeping the password secure is necessary for the protection of the Account. This is a good thing that can present a significant problem for businesses and personal estates when the User is suddenly no longer available or is unable for health reasons to provide the password for access to the Account for information that could be vital to the business or the estate of the User. Many times the surviving spouse is left without the knowledge of the password for the Account.

Preparing for such potential emergencies by sharing the password is not a satisfactory or viable solution, since it is most likely to result in providing access to personal and business data that the User prefers to keep private until such time as the User is unable for some reason to access the Account.

The problem of how to allow executors, business associates and family members to access the Account without giving them passwords that allow full and current access into the Account has resulted in many problems at the time of the death or disability of the User. Many put the password in their will, give it to a trusted advisor or email the password to themselves, but the password is still exposed and many times not available when needed. There are programs that allow multiple passwords and account information to be Stored, but they still require a password, so the problem is not solved.

Most Users do want specified family members, certain business associates, or their attorney to be able to access their personal and business data and financial account information when and if it becomes necessary, but they do not want to give up their privacy and control by sharing the password to access the Account until and unless they are not able to handle their affairs. Unfortunately, when that time comes, they are also not able to share the password to the Account. Resolving this problem is important to any User who has an Account.

There are many different methods of password verification. Upon accessing a protected resource in any Account, the User is normally challenged to authenticate the access, using the login method defined for the Account currently being accessed. Most allow the User to create a plain or “in the clear” phrase or password. Some programs do allow the User to be involved in the choosing of the password, and others generate a password that must be used or one that is a suggestion to help the User create the password. However derived, according to the security requirements of the Account, the password entered is encrypted using the encryption method used by the Account or encrypted by a third party encryption program. The resulting encrypted password is then Stored for later comparison. Depending on the security requirements of the Account the password may be Stored without encryption or in clear-text for later comparison.

When the User accesses the Account, the password entered is normally encrypted using the same encryption method and algorithms used in the initial encryption process. If the result matches the Stored encrypted password, the User is authenticated.

### SUMMARY OF THE INVENTION

The invention allows the User to create auxiliary password Key Elements (hereinafter referred to as “Key Elements”) that can be used to allow access to the Account after the occurrence of an event such as death of the User or other time or event specified by the User (hereinafter referred to as an “Event”).

The present invention combines two or more Key Elements to produce an auxiliary password that can be used as a valid alternate to a User's password.

The present invention allows any number of Key Elements to be composed of any number of characters and allows the Key Elements to be entered in any order, without compromising secure access to the Account.

The invention allows the User to manually or automatically create Key Elements and, as the User sees fit, to distribute them to parties who are trusted by the User (hereinafter referred to as “Trusted Parties”) who agree to use the Key Elements only after the specified Event. Because it takes more than one Key Element to form a valid auxiliary password, the Key Elements allow access to the Account only with the concurrence and participation of a specified number of Trusted Parties.

Recognizing that the owner of an Account may not be the owner of the related program, machine, device, software or hardware. “Account” shall also mean anyone who owns or controls the program, machine, device, software, hardware, the specifications of the Account or the programming of the authorized access process, or anyone who has control of the authorized access to the account.

According to the specifications of the Account, the auxiliary password can also be programmed to bypass any PIN or other secondary access method. This allows the Key Element holders to have full access to the Account without the need for the User to disclose the User's PIN or other secondary access method.

The purpose of the invention is to provide an alternate method of access to password protected data, but at the same time to allow the User the option to remain in control and to keep the data secure and private unless and until certain predetermined events occur. Further, the present invention allows for a specified degree of flexibility not available in the User's password structure, but this flexibility does not affect the security of the data.

The present invention allows a User to create Key Elements that, when combined, will serve as an alternate method of access to password and if specified, PIN protected data. Furthermore, the invention allows for the Key Elements to be concatenated in any order, as long as each Key Element is entered exactly and in its entirety.

The Key Elements can be generated or created manually or automatically. The minimum number of Key Elements required is two. The maximum number of key elements is unlimited, but is constrained by the number of possible combinations of the key elements. Each Key Element is composed of a string of letters, numbers, and/or keyboard characters. The Key Elements do not have to contain the same number of characters. Each Key Element can be different in structure and can be a single letter, a series of letters, numbers and keyboard characters, a single word, a phrase, a sentence, or a paragraph.

The User can change the User's password, and any secondary access methods such as a PIN, as often as the User chooses, without changing or altering any of the Key Elements. The User can change the Key Elements at any time without altering the User's password or any secondary access methods. This allows the User to immediately revoke Account access to any or all of the previous Key Element holders without altering the User's normal Account access.

There are many important personal and business applications for the current invention:

As an example: The User can create two Key Elements and share them with two or more Trusted Parties. Instructions accompanying the Key Elements would include a specific time or occurrence when the Key Element would be used by the Trusted Parties, such as upon the death or incapacitation of the User.

Specific advantages of the current invention to the User include, but are not limited to: The Key Elements must be used together. Neither will authorize access to the Account if used alone, so both of the Key Element holders must agree that the specific time or occurrence specified by the User necessitates access to the Account.

If more than two Key Elements are created by the User, then according to the specifications and programming of the Account, the correct number of Key Elements will be required to access the Account. The valid auxiliary password can be entered in the same manner as the User's password or a special entry may be provided by the Account. The Key Element entries can be entered together at one time in any order, or individually in separate fields or methods as specified and provided by the Account. If not entered together at one time, they can be concatenated in any order or processed individually as specified by the Account.

The User is not required to share the active account password or PIN that authorizes access to the Account, so the User retains control and can change the active password and/or PIN anytime, without having to change any of the active Key Elements.

The User can change or delete any of the active Key Elements at any time without affecting the User's password, PIN or secondary access methods.

The active Key Elements can be used in any order as a valid auxiliary password to gain access to the Account. In other words, there is a built-in flexibility to the process which allows the holders of the Key Elements to enter the Key Elements in any order, as long as each Key Element is entered exactly and in its entirety. This flexibility means that the User does not have to prescribe the order of the Key Elements. If there are only two Key Elements involved, then they can be entered KeyElement1KeyElement2 or KeyElement2KeyElement1. Either of the configurations will authorize access to the Account. If there are more than two Key Elements, then the number required to access the Account will increase, depending on the combination possibilities, or the prior specification of the Account.

### BRIEF DESCRIPTION OF THE DRAWINGS

Understanding that these drawings depict only sample embodiments and are not therefore to be considered to be limiting the scope of the invention.

FIG. 1 illustrates the creation, concatenation and storage of two Key Elements as valid auxiliary passwords.

FIG. 2 illustrates the use of two Key Elements concatenated to form a valid auxiliary passwords.

FIG. 3 illustrates the creation, concatenation and storage of three Key Elements as valid auxiliary passwords.

FIG. 4 illustrates the use of three Key Elements concatenated to form a valid auxiliary password.

FIG. 5 illustrates the creation, concatenation and storage of four Key Elements with any two used as valid auxiliary passwords.

FIG. 6 illustrates the use of any two Key Elements of Key Elements 1 & 2 & 3 & 4 concatenated to form a valid auxiliary password.

FIG. 7 illustrates the creation, concatenation and storage of any number of Key Elements as valid auxiliary passwords.

FIG. 8 illustrates the use of any two Key Elements of Key Elements 1 & 2 & 3 & 4 concatenated to form a valid auxiliary password.

### DETAILED DESCRIPTION OF THE DRAWINGS

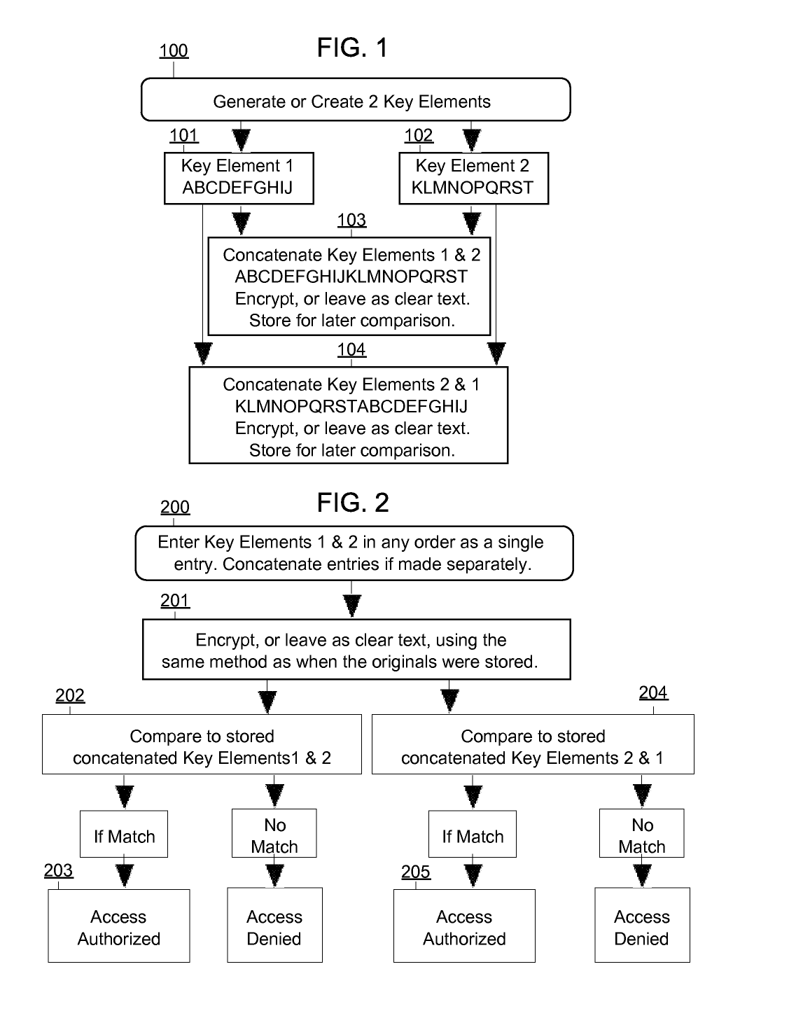

FIG. 1

Two Key Elements are created by the Account, entered by the User or a combination of both depending on the security requirements of the Account.

The two Key Elements specified by the Account are captured by the Account either in memory or in Storage.

Depending on the security requirements of the Account the Key Elements or combinations of Key Elements may be Stored without encryption or in clear-text for later comparison.

### FIG. 2

The two required Key Elements 1 & 2 are entered in the same manner as the User's password or special entries may be provided by the Account. The Key Element entries can entered together at one time in any order or individually in separate fields or methods as specified and provided by the Account. If not entered together at one time, they can be concatenated in any order or processed individually as specified by the Account.

The entry resulting from [200] is captured by the Account either in memory or in Storage. The entry is processed in the same manner (clear-text or encryption) as the original concatenated Key Element to be used for comparison.

The processed entry is compared to the Stored Key Elements 1 & 2

If the processed entry matches, Access is authorized and if specified by the Account, any PIN or secondary access method is bypassed. If the processed entry does not match, access is denied.

The processed entry is compared to the Stored Key Elements 2 & 1

If the processed entry matches, access is authorized and if specified by the Account, any PIN or secondary access method is bypassed. If the processed entry does not match, access is denied.

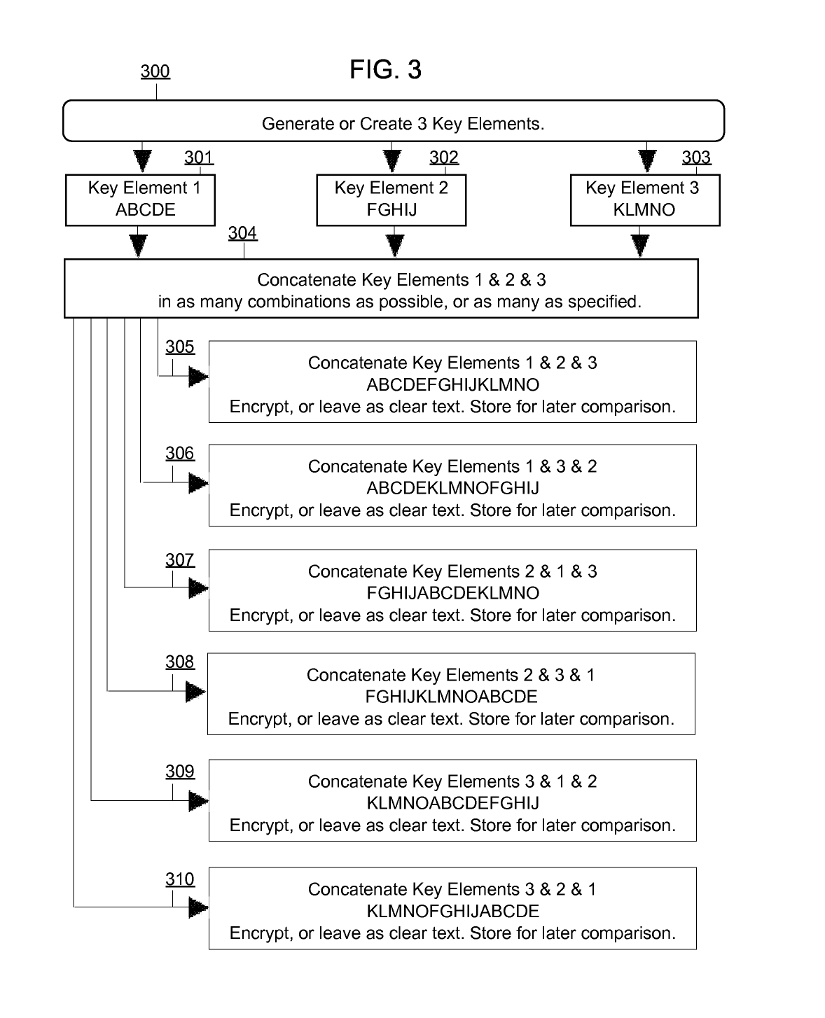

### FIG. 3

Three Key Elements are created by the Account, entered by the User or a combination of both, depending on the security requirements of the Account.

The three Key Elements specified by the Account are captured by the Account either in memory or in Storage.

Concatenate Key Elements 1 & 2 & 3 in as many combinations as possible, or as many as specified and Store each one.

Depending on the security requirements of the Account, the Key Elements, concatenated Key Elements or combinations of Key Elements may be Stored without encryption or in clear-text for later comparison.

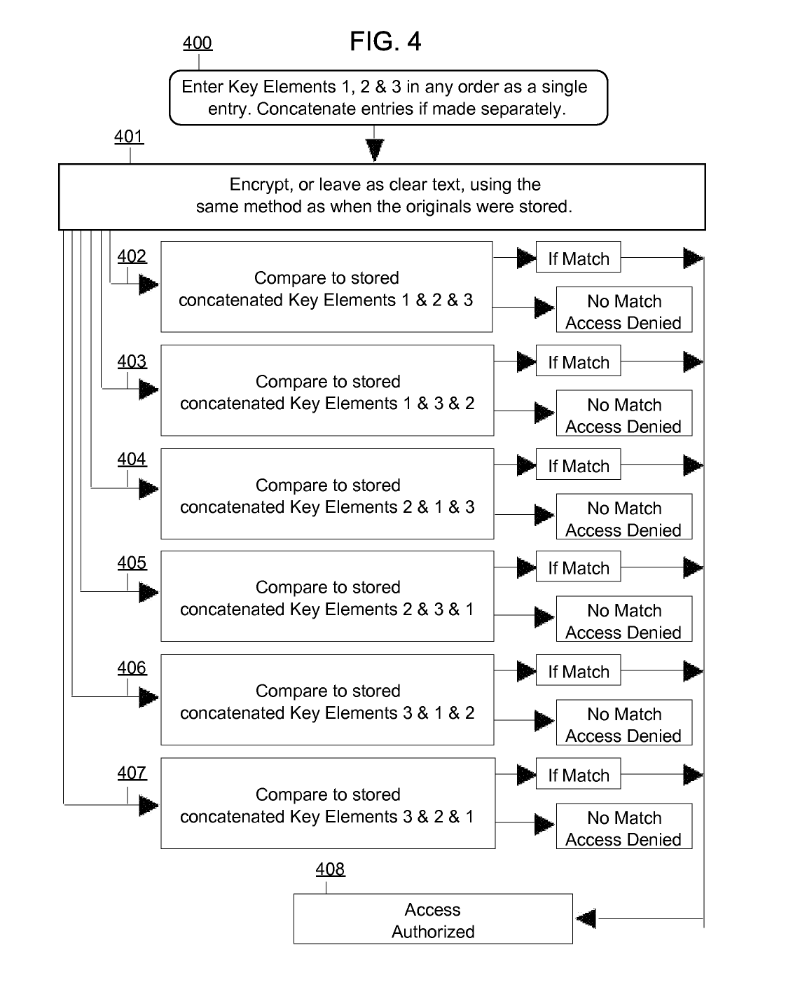

### FIG. 4

The Key Elements 1 & 2 & 3 are entered in the same manner as the User's password or special entries may be provided by the Account. The Key Element entries can be entered together at one time in any order, or individually in separate fields, or methods as specified and provided by the Account. If not entered together at one time, they can be concatenated in any order or processed individually as specified by the Account.

The entry resulting from [400] is captured by the Account either in memory or in Storage. The entry is processed in the same manner (clear-text or encryption) as the original concatenated Key Element to be used for comparison.

The processed entry is compared to the Stored concatenated Key Elements 1 & 2 & 3. If the processed entry matches, Access is authorized and if specified by the Account, any PIN or secondary access method is bypassed. If the processed entry does not match, access is denied.

The processed entry is compared to the Stored concatenated Key Elements 1 & 3 & 2. If the processed entry matches, Access is authorized and if specified by the Account, any PIN or secondary access method is bypassed. If the processed entry does not match, access is denied.

The processed entry is compared to the Stored concatenated Key Elements 2 & 1 & 3. If the processed entry matches, Access is authorized and if specified by the Account, any PIN or secondary access method is bypassed. If the processed entry does not match, access is denied.

The processed entry is compared to the Stored concatenated Key Elements 2 & 3 & 1. If the processed entry matches, Access is authorized and if specified by the Account, any PIN or secondary access method is bypassed. If the processed entry does not match, access is denied.

The processed entry is compared to the Stored concatenated Key Elements 3 & 1 & 2. If the processed entry matches, Access is authorized and if specified by the Account, any PIN or secondary access method is bypassed. If the processed entry does not match, access is denied.

The processed entry is compared to the Stored concatenated Key Elements 3 & 2 & 1. If the processed entry matches, Access is authorized and if specified by the Account, any PIN or secondary access method is bypassed. If the processed entry does not match, access is denied.

If the processed entry matches any of the stored concatenated Key Elements, it is a valid auxiliary password and access to the Account is authorized. If specified by the Account, any PIN or secondary access method is bypassed.

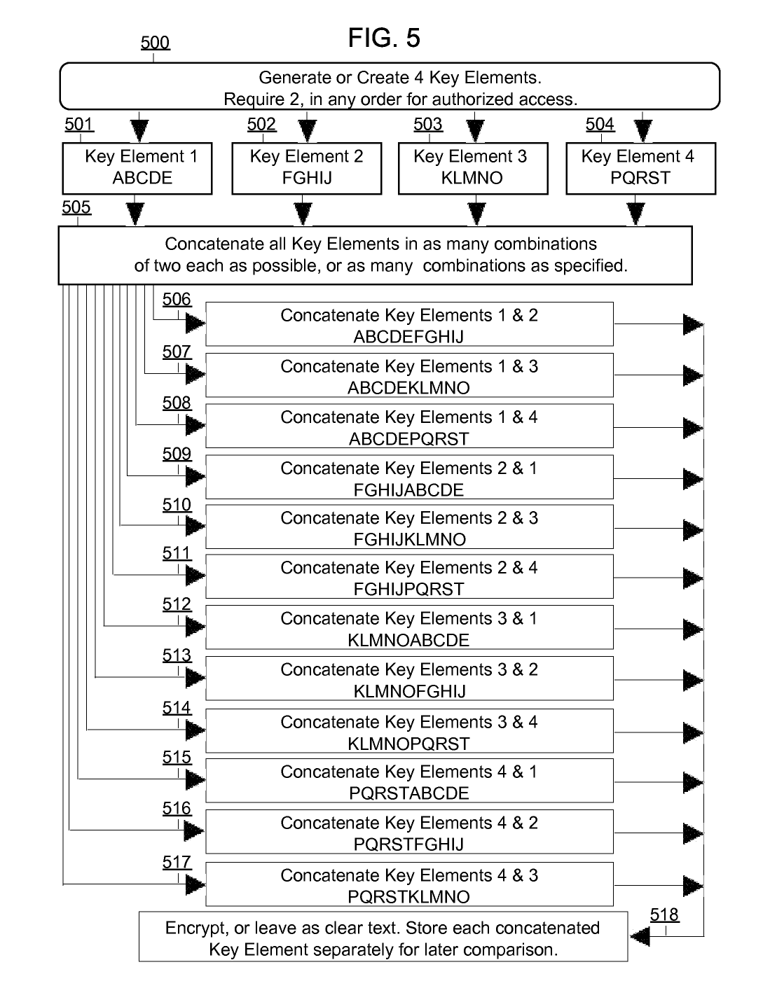

### FIG. 5

Four Key Elements are created by the Account, entered by the User, or a combination of both, depending on the security requirements of the Account.

The four Key Elements specified by the Account are captured by the Account either in memory or in Storage.

Concatenate Key Elements 1 & 2 & 3 & 4 in as many combinations of two each as possible, or as many as specified, and Store each one.

Depending on the security requirements of the Account, the Key Elements, concatenated Key Elements or combinations of Key Elements may be Stored without encryption or in clear-text for later comparison.

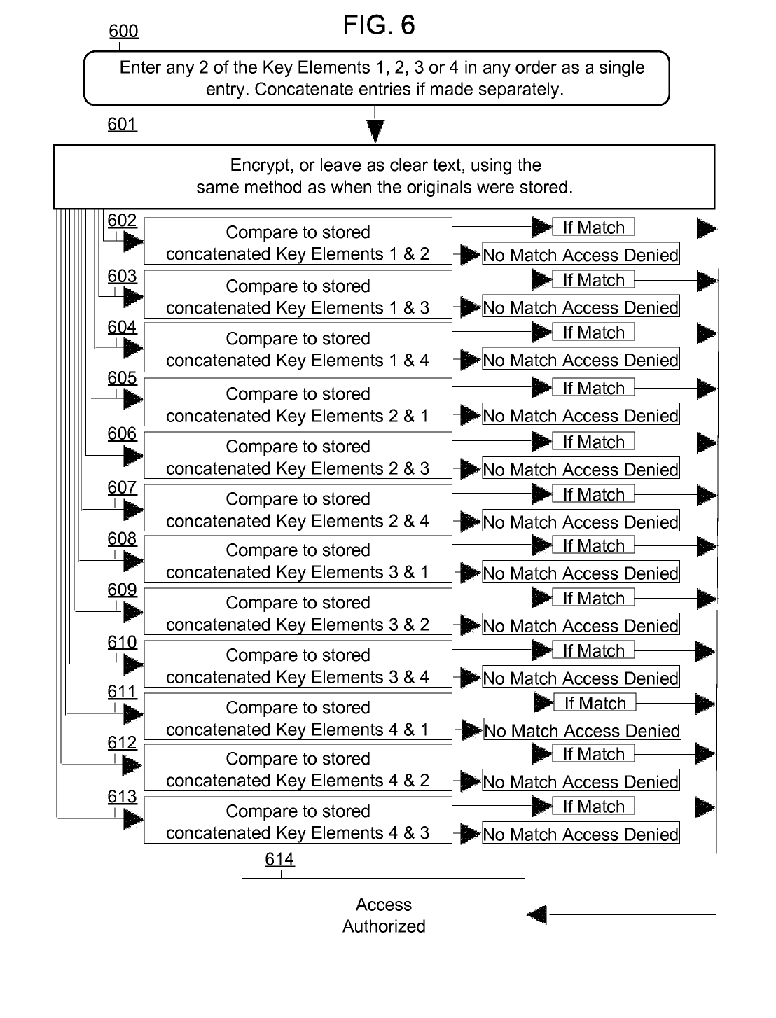

### FIG. 6

The two required Key Elements of Key Elements 1 & 2 & 3 & 4 are entered in the same manner as the User's password or special entries may be provided by the Account. The Key Element entries can entered together at one time in any order or individually in separate fields or methods as specified and provided by the Account. If not entered together at one time, they can be concatenated in any order or processed individually as specified by the Account.

The entry resulting from [600] is captured by the Account either in memory or in Storage. The entry is processed in the same manner (clear-text or encryption) as the original concatenated Key Element to be used for comparison.

The processed entry is compared to the Stored concatenated Key Elements 1 & 2. If the processed entry matches, Access is authorized and if specified by the Account, any PIN or secondary access method is bypassed. If the processed entry does not match, access is denied.

The processed entry is compared to the Stored concatenated Key Elements 1 & 3. If the processed entry matches, Access is authorized and if specified by the Account, any PIN or secondary access method is bypassed. If the processed entry does not match, access is denied.

The processed entry is compared to the Stored concatenated Key Elements 1 & 4. If the processed entry matches, Access is authorized and if specified by the Account, any PIN or secondary access method is bypassed. If the processed entry does not match, access is denied.

The processed entry is compared to the Stored concatenated Key Elements 2 & 1. If the processed entry matches, Access is authorized and if specified by the Account, any PIN or secondary access method is bypassed. If the processed entry does not match, access is denied.

The processed entry is compared to the Stored concatenated Key Elements 2 & 3. If the processed entry matches, Access is authorized and if specified by the Account, any PIN or secondary access method is bypassed. If the processed entry does not match, access is denied.

The processed entry is compared to the Stored concatenated Key Elements 2 & 4. If the processed entry matches, Access is authorized and if specified by the Account, any PIN or secondary access method is bypassed. If the processed entry does not match, access is denied.

The processed entry is compared to the Stored concatenated Key Elements 3 & 1. If the processed entry matches, Access is authorized and if specified by the Account, any PIN or secondary access method is bypassed. If the processed entry does not match, access is denied.

The processed entry is compared to the Stored concatenated Key Elements 3 & 2. If the processed entry matches, Access is authorized and if specified by the Account, any PIN or secondary access method is bypassed. If the processed entry does not match, access is denied.

The processed entry is compared to the Stored concatenated Key Elements 3 & 4. If the processed entry matches, Access is authorized and if specified by the Account, any PIN or secondary access method is bypassed. If the processed entry does not match, access is denied.

The processed entry is compared to the Stored concatenated Key Elements 4 & 1. If the processed entry matches, Access is authorized and if specified by the Account, any PIN or secondary access method is bypassed. If the processed entry does not match, access is denied.

The processed entry is compared to the Stored concatenated Key Elements 4 & 2. If the processed entry matches, Access is authorized and if specified by the Account, any PIN or secondary access method is bypassed. If the processed entry does not match, access is denied.

The processed entry is compared to the Stored concatenated Key Elements 4 & 3. If the processed entry matches, Access is authorized and if specified by the Account, any PIN or secondary access method is bypassed. If the processed entry does not match, access is denied.

If the processed entry matches any of the stored concatenated Key Elements, it is a valid auxiliary password and access to the Account is authorized. If specified by the Account, any PIN or secondary access method is bypassed.

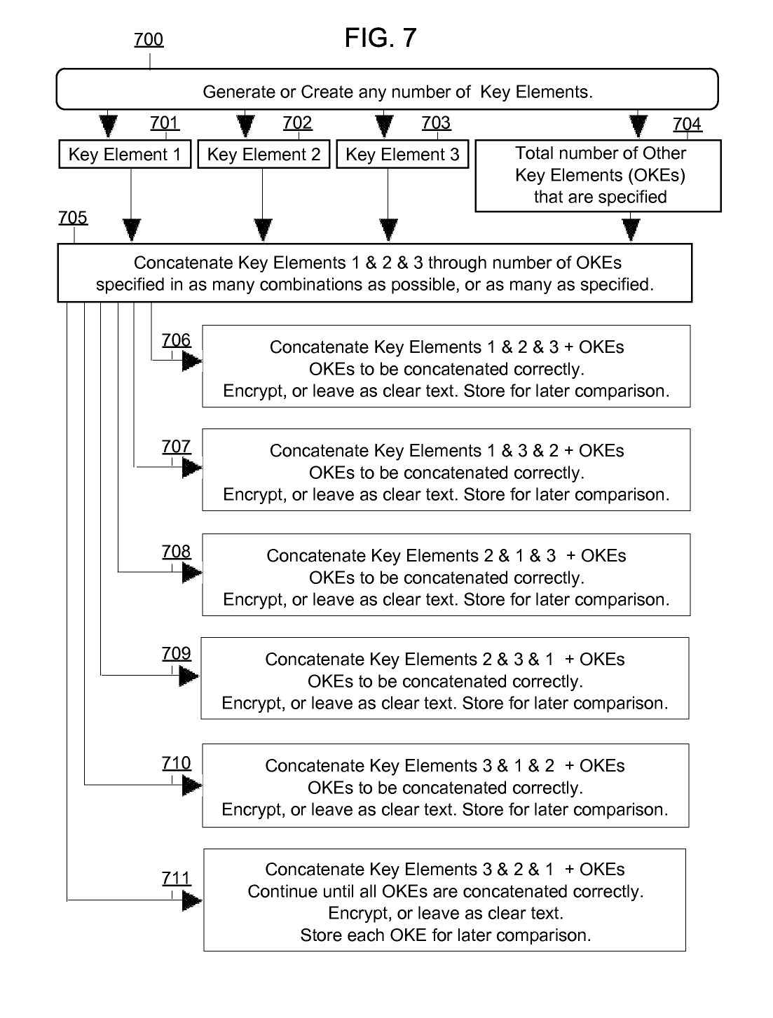

### FIG. 7

Any number of Key Elements are created by the Account, entered by the User, or a combination of both, depending on the security requirements of the Account.

The Key Elements specified by the Account are captured by the Account either in memory or in Storage. The total number of Key Elements that are specified in addition to Key Element 1 & 2 & 3 are identified as Other Key Elements (OKEs)

Concatenate Key Elements 1 & 2 & 3 & OKEs in as many combinations of as possible, or as many as specified and Store each one.

Depending on the security requirements of the Account, the Key Elements, concatenated Key Elements or combinations of Key Elements may be Stored without encryption or in clear-text for later comparison.

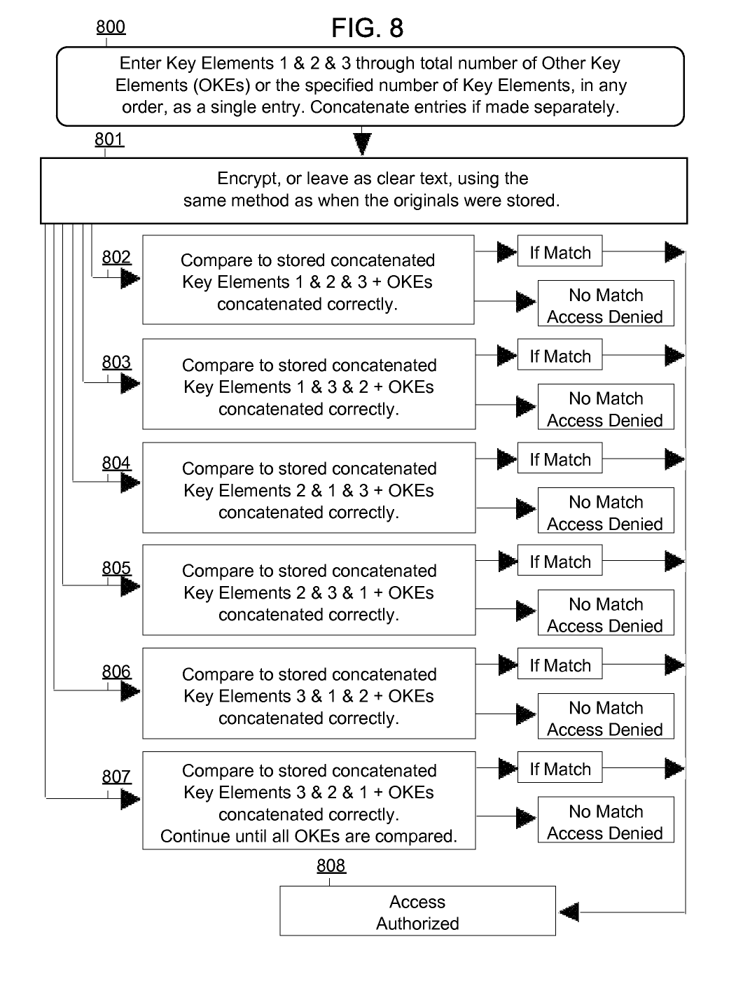

### FIG. 8

The Key Elements 1 & 2 & 3 through the total number of Other Key Elements (OKEs) are entered in the same manner as the User's password or special entries may be provided by the Account. The Key Element entries can entered together at one time in any order or individually in separate fields or methods as specified and provided by the Account. If not entered together at one time, they can be concatenated in any order, or processed individually, as specified by the Account.

The entry resulting from [800] is captured by the Account either in memory or in Storage. The entry is processed in the same manner (clear-text or encryption) as the original concatenated Key Element to be used for comparison.

The processed entry is compared to the Stored concatenated Key Elements 1 & 2 & 3+OKEs concatenated correctly. If the processed entry matches, Access is authorized and if specified by the Account, any PIN or secondary access method is bypassed. If the processed entry does not match, access is denied.

The processed entry is compared to the Stored concatenated Key Elements 1 & 3 & 2+OKEs concatenated correctly. If the processed entry matches, Access is authorized and if specified by the Account, any PIN or secondary access method is bypassed. If the processed entry does not match, access is denied.

The processed entry is compared to the Stored concatenated Key Elements 2 & 1 & 3+OKEs concatenated correctly. If the processed entry matches, Access is authorized and if specified by the Account, any PIN or secondary access method is bypassed. If the processed entry does not match, access is denied.

The processed entry is compared to the Stored concatenated Key Elements 2 & 3 & 1+OKEs concatenated correctly. If the processed entry matches, Access is authorized and if specified by the Account, any PIN or secondary access method is bypassed. If the processed entry does not match, access is denied.

The processed entry is compared to the Stored concatenated Key Elements 3 & 1 & 2+OKEs concatenated correctly. If the processed entry matches, Access is authorized and if specified by the Account, any PIN or secondary access method is bypassed. If the processed entry does not match, access is denied.

The processed entry is compared to the Stored concatenated Key Elements 3 & 2 & 1+OKEs concatenated correctly. If the processed entry matches, Access is authorized and if specified by the Account, any PIN or secondary access method is bypassed. If the processed entry does not match, access is denied.

Continue until all OKEs are compared.

The processed entry is compared to the all of the Stored concatenated Key Elements and OKEs. If the processed entry matches, Access is authorized and if specified by the Account, any PIN or secondary access method is bypassed. If the processed entry does not match, access is denied.

### DETAILED DESCRIPTION OF THE INVENTION

The auxiliary password is formed by the specified number of Key Elements. These Key Elements could easily be generated at the same time as the generation, selection or creation of the User's password whether accomplished by the User or an automated system. Best practice is to allow the User to generate the Key Elements only after the User has accessed the account by using the User's password. For best security the auxiliary password should be made up of at least 1 lowercase letter, 1 uppercase letter, 1 number and 1 special character if the English language is used and similar mix of the type of characters if the auxiliary password is made up using a language or a combination of languages. Each Key Element can be different in structure and can be a single letter, a series of letters, numbers and keyboard characters, a single word, a phrase, a sentence, or a paragraph. The auxiliary password can be as short or as long as needed but must be at least as long as the number of Key Elements specified by the Account. The Key Elements can be chosen by the User or generated by a program. The recommended auxiliary password is 20 characters long such as ABCDEFGHIJKLMNOPQRST (FIG. 1 [100]) and be divided equally into two Key Elements such as ABCDEFGHIJ (FIG. 1 [101]) and KLMNOPQRST (FIG. 1 [102]). In this case, the auxiliary password works as a valid password when the Key Elements are assembled in any order such as ABCDEFGHIJKLMNOPQRST (FIG. 1 [103]) or KLMNOPQRSTABCDEFGHIJ (FIG. 1 [104]). It can be split in equal or unequal Key Elements such as ABCD and EFGHIJjKLMNOPQRST. In this case, the auxiliary password is a valid auxiliary password when the Key Elements are assembled in any order such as ABCDEFGHIJKLMNOPQRST or EFGHIJKLMNOPQRSTABCD.

If three key elements are used such as ABCDE, FGHIJ, and KLMNO, they can be assembled and used as a valid auxiliary password as ABCDEFGHIJKLMNO (FIG. 3 [305]), ABCDEKLMNOFGHIJ (FIG. 3 [306]), FGHIJABCDEKLMNO (FIG. 3 [307]), FGHIJKLMNOABCDE (FIG. 3 [308]), KLMNOABCDEFGHIJ (FIG. 3 [309]) and KLMNOFGHIJABCDE (FIG. 3 [310]). Each combination would work as a valid auxiliary password. There can be any number of Key Elements with the corresponding number of possible combinations. All possible combinations of the Key Elements in the auxiliary password can be used as a valid auxiliary password or according to the requirements of the account, only certain combinations could be designated as a valid auxiliary password. Trusted Parties can be told that not all Key Element combinations work and to keep trying different combinations or different Trusted Parties until a valid auxiliary password is created. Different combinations of Key Elements could be used. Five Key Elements could be created but combinations of only three of the Key Elements are required to form a valid auxiliary password. Any three of the five Key Elements could be used to form a valid auxiliary password and allow entry into the Account.

For Business or Social Accounts, Key Elements could be given to associates that are not Trusted Parties but have a business or social relationship with the User. Each key holder or Trusted Party must combine their Key Element with the Key Elements of the proper number of other key holders or Trusted Parties, combined in any order, to complete a valid auxiliary password. The auxiliary password thus created would be a valid password that could be used to access the Account. If desired, each Key Element holder could access a common Account using their individual passwords and then use their Key Element as their portion of a valid auxiliary password. This auxiliary password would be authenticated and used to allow access to a higher or different level of Account authorization. The Key Elements could be entered by each key holder or Trusted Party independently and the entered Key Element would be Stored by the Account until the number of Key Elements entered comprised a valid auxiliary password. The Key Elements would then remain private and could be used again for subsequent accesses in combination with different key holders and Trusted Parties. If not kept private, best practice would be to change all of the Key Elements each time a combination is used for Account access. According to the security requirements of the Account, an alert email or other notification should be sent to the User each time an auxiliary password is used for access to the Account.

The Key Elements can be concatenated in each of the possible combinations at the time they are created and each combination can be encrypted and Stored for later comparison, or each Key Element can be encrypted and Stored separately for later comparison. According to the security requirements of the Account, the Key Elements or combinations of Key Elements may be Stored without encryption or in clear-text.

Each possible combination of Key Elements in the auxiliary password is Stored by the Account or third party mechanism. Storage for each concatenated auxiliary password is provided, in addition to the User's password. If two Key Elements were used (Key Element A & Key Element B), the User's password, the concatenated Key Elements AB, and the concatenated Key Elements BA are Stored separately for later comparison. According to the security needs of the Account, they could be encrypted and Stored, Stored without encryption or in any other method used by the Account. The same storage process can be used for all of the concatenated Key Elements or a different storage process can be used for each Key Element, as long as the comparison of each Key Element or concatenated Key Elements is made using the respective storage method. If three or more Key Elements are used, each possible combination (or the valid sub sets of combinations planned to be a valid auxiliary password) are Stored for later comparison. Storage would typically be provided for the User's password, the ABCDEFGHIJKLMNO concatenated Key Element (FIG. 3 [305]), the ABCDEKLMNOFGHIJ concatenated Key Element (FIG. 3 [306]), the FGHIJABCDEKLMNO concatenated Key Element (FIG. 3 [307]), the FGHIJKLMNOABCDE concatenated Key Element (FIG. 3 [308]), the KLMNOABCDEFGHIJ concatenated Key Element (FIG. 3 [309]) and the KLMNOFGHIJABCDE concatenated Key Element (FIG. 3 [310]) and so on for additional Key Elements. If not all combinations are intended to each be a valid auxiliary password, then the sub set combinations that are not to be used would not have to be Stored. Each combination can be Stored on the same program, machine or device or on separate programs, machines or devices.

The specified number of Key Elements are required to be concatenated to form a usable auxiliary password which then can be used as a valid password. If a single access is used where the Key Elements have to be assembled manually to form the auxiliary password prior to entry, at least one of the key holders must also have the Username or Login ID for the account. If key holders are able to keep their Key Element private by logging into an Account with their own password before entering their Key Element, a separate Username or Login ID may or may not be required by the Account.

The best way to transfer one of the Key Elements to a Trusted Party or Key Holder is to meet with them privately, tell them the details and importance of the Key Element and give the Key Element and your Username or Login ID to the Trusted Party or Key Holder in person and in private. A reasonable way to send one of the Key Elements to a Trusted Party or Key Holder is to call them and tell them the details and importance of the Key Element. Then email them one of the Key Elements as the ONLY thing in the body of the email and use “Here it is” or other “non meaningful” phrase as the subject of the email. Do the same for your Username or Login ID. You could also use the post office or special delivery services. When relaying one of the Key Elements other than in person you should never mention the purpose of the enclosure.

In summary, the current invention aids the User while the User is alive and well, since the process does not expose current access to a password protected Account and it does not allow other than User access to the Account without concurrence of the prescribed number of parties personally chosen and trusted by the User.

The features and advantages of the invention allow protection from current access to financial and personal information while allowing total access to Trusted Parties when specified events occur. There are obvious and various modifications, additions, applications, embodiments and alterations within the scope herein that may be made to the invention, by one skilled in the art, in which the invention would be of significant utility without departing from the spirit and scope of the invention as defined.

What is claimed is:

1. A method for creating and using an auxiliary access password which can be used as an alternative password or as the primary password in the absence of a primary password to allow access to an account, comprising:
(1) Two or more auxiliary access password key elements composed of any number of characters in any language that when concatenated in any order or in any specified order can be used to allow access to an account as a valid alternate to the primary password or as the primary password in the absence of a valid primary password.
(2) Any number of key elements can be created and when all of the key elements are concatenated in any order or in any specified order compose a valid alternate to the primary password or as the primary password in the absence of a valid primary password.
(3) Any number of key elements can be created and the key elements can be divided into multiple designated subsets where each of the subsets of key elements can be concatenated in any order or in any specified order to compose a valid alternate to the primary password or as the primary password in the absence of a valid primary password.
(4) The key elements can be created by an automatic method, a mechanical method, a manual method, input by the user or any combination of methods.
(5) The method of the auxiliary access password entry for access to an account may be the same as the entry method of the primary password or by an alternative method.
(6) When the account allows, the valid auxiliary access password can be used to bypass any pin or other secondary or alternate access method.
